(19) United States
(12) Patent Application Publication
(10) Pub. No.: US 2023/0369669 A1
(43) Pub. Date: Nov. 16, 2023

(54) ELECTROLYTE SOLUTION FOR LITHIUM SULFUR BATTERY, PREPARATION METHOD AND APPLICATION THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Haijun Yu, Foshan (CN); Ting Peng, Foshan (CN); Yinghao Xie, Foshan (CN); Hongmei Zhu, Foshan (CN); Changdong Li, Foshan (CN)

(73) Assignees: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(21) Appl. No.: 18/225,172

(22) Filed: Jul. 24, 2023

Related U.S. Application Data
(63) Continuation of application No. PCT/CN2021/142393, filed on Dec. 29, 2021.

(30) Foreign Application Priority Data
Jan. 22, 2021 (CN) 202110087962.5

(51) Int. Cl. H01M 10/54; H01M 10/052; H01M 10/0569; H01M 10/0567

(52) U.S. Cl. CPC H01M 10/54; H01M 10/052; H01M 10/0569; H01M 10/0567; H01M 2300/0037; H01M 2300/0034

(57) ABSTRACT

The invention belongs to the field of an electrolyte solution for a battery, and discloses a lithium-sulfur battery electrolyte and a preparation method and application thereof. The electrolyte solution comprises the following components: an organic solvent, an electrolyte and an additive; the organic solvent is 1,1,2, 2-tetrafluoroethyl 2,2,3,3-tetrafluoropropyl ether and 1,3-dioxolane; the electrolyte is bis(hexafluoroethane) sulfonamide lithium salt and LiCF₃SO₃; the additive is a lithium-sulfur compound, wherein the lithium-sulfur compound is Li₆S₂. The invention recovers an electrolyte solution from a lithium-sulfur battery, and then extracts the Li element in the electrolyte solution, which is recycled for preparation of a electrolyte solution of the lithium-sulfur battery; in addition, it can also enrich the organic components in the electrolyte solution of the waste lithium-sulfur battery, facilitating a centralized processing and reduction of leakage pollution.

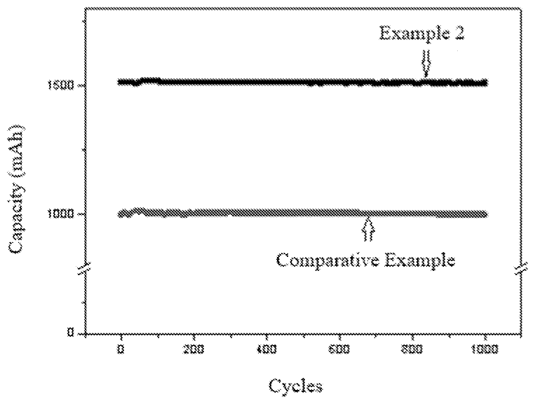

### CROSS-REFERENCE TO RELATED APPLICATIONS

The present application is a continuation application of PCT application No. PCT/CN2021/142393 filed on Dec. 29, 2021, which claims the benefit of Chinese Patent Application No. 202110087962.5 filed on Jan. 22, 2021. The contents of all of the aforementioned applications are incorporated by reference herein in their entirety.

### TECHNICAL FIELD

The present invention relates to the field of battery electrolyte solution, in particular to an electrolyte solution for a lithium-sulfur battery and a preparation method and application thereof.

### BACKGROUND

The research on lithium-sulfur secondary batteries with high-performance sulfur-carbon cathodes published by the Canadian Nazar research group in 2009 on Nat. Mater. attracted worldwide attention, and the research on lithium-sulfur batteries quickly reached a climax. At present, the development of lithium-sulfur batteries is limited by many technical problems. The main manifestations are: (1) The dissolution of lithium polysulfide, the discharge product of sulfur, in the electrolyte solution of the organic lithium-sulfur battery causes the “shuttle phenomenon”, causing serious corrosion of metal lithium and loss of active materials, which is also main reason for the overcharge and performance deterioration of lithium-sulfur batteries. The main reasons for the deterioration of performance; (2) The poor ionic and electronic conductivity of the sulfur element and the discharge product Li₂S, which affects the battery's energy density and active material utilization; (3) The dendrite and powdering problems of metallic lithium; (4) The large density difference between the charged product and the discharged product of the positive electrode causing a serious expansion of the electrode volume (approximately 79%). In the past ten years, many breakthrough developments have been achieved in the performance and mechanism research of lithium-sulfur batteries, and basic research progresses and exemplary applications of lithium-sulfur batteries are constantly emerging. In the future, if lithium-sulfur batteries can achieve commercial applications, it will definitely change the pattern of new energy storage systems and our current living conditions. Among the several prominent problems of lithium-sulfur batteries, the most prominent one is the shuttle phenomenon of the battery. The entire cycle of lithium-sulfur batteries are accompanied by the shuttle phenomenon, especially during the charging process, leading to serious battery overcharge, low coulomb efficiency, serious self-discharge, and corrosion of metal lithium.

Optimizing the design of the electrolyte solution for lithium-sulfur batteries is one of the effective methods to reduce a shuttle phenomenon. The optimization of the electrolyte solution of a lithium-sulfur battery includes component optimization and structural design, selection of appropriate solvents or functional additives, to prevent the reaction of lithium polysulfide with lithium metal or reduce its solubility in the electrolyte solution of the lithium-sulfur battery. Adding a functional intermediate layer to the electrolyte solution of a lithium-sulfur battery is also an effective means to block or adsorb lithium polysulfide.

So far, there have been extensive research reports on electrolyte solution optimization of lithium-sulfur batteries. However, most lithium-sulfur battery electrolyte solution optimization has room for improvement in reducing a shuttle phenomenon. Therefore, it is urgent to find a new type of lithium-sulfur battery electrolyte solution to avoid the shuttle phenomenon in the field of lithium-sulfur batteries. In addition, at present, the recovery of lithium batteries focuses on the recovery of cathode materials and current collectors, and the recovery of electrolyte solution for lithium-sulfur batteries is less involved. As a toxic chemical reagent, the electrolyte solution of a lithium-sulfur battery cannot be discarded at will. This will not only pollute the environment, but also cause a waste of resources. Therefore, by recycling the electrolyte solution of the waste lithium-sulfur battery for preparation of an electrolyte solution of the new type of lithium-sulfur battery, the resources can be recycled and utilized.

### SUMMARY OF THE INVENTION

The present invention aims to solve at least one of the technical problems existing in the above-mentioned prior art. To this end, the present invention provides an electrolyte solution for a lithium-sulfur battery and a preparation method and application thereof. The electrolyte solution for a lithium-sulfur battery has excellent conductivity, with a conductivity of 2.57-2.79 mS/cm, and Li₆S₂ is used as an additive, which produces a buffering effect to reduce dissolution of the positive electrode active material and alleviates the “shuttle phenomenon”.

In order to achieve the above objectives, the present invention adopts the following technical solutions:

An electrolyte solution for a lithium-sulfur battery comprising an organic solvent, an electrolyte, and an additive; the organic solvent is 1,1,2,2-tetrafluoroethyl 2,2,3,3-tetrafluoropropane ether and 1,3-dioxolane; the electrolyte is a lithium salt; the additive is a lithium-sulfur compound; the lithium-sulfur compound is Li₆S₂.

Preferably, the lithium salt is bis(hexafluoroethane) sulfonamide lithium salt and LiCF₃SO₃.

Preferably, the electrolyte solution for the lithium-sulfur battery has a dielectric constant of 37.26-46.68 F/m, and a conductivity of 2.57-2.79 mS/cm.

Preferably, the organic solvent, the electrolyte and the additive are in a mass volume ratio of (50-60):(30-40):(10-20).

The mixture of the two solvents 1,1,2,2-Tetrafluoroethyl 2,2,3,3-Tetrafluoropropyl ether and 1,3-dioxolane has a decisive influence on properties of the electrolyte solution for a lithium sulfur battery, such as viscosity, dielectric constant, electrical conductivity etc. These properties have an impact on a shuttle behavior of a polysulfide compounds. The smaller the viscosity, the greater the dielectric constant and the conductivity, the weaker the shuttle behavior.

Bis(hexafluoroethane) sulfonamide lithium salt has a molecular formula of [CF₃CF₂SO₂N-SO₂CH₂CH₃] Li⁺; the essential characteristics of bis(hexafluoroethane) sulfonamide lithium salt and LiCF₃SO₃ determine that it has high conductivity as an electrolyte and is suitable for migration of current carriers. The combination of the two components has a better effect.

A preparation method of the electrolyte solution for a lithium-sulfur battery comprises the following steps:

Mixing an organic solvent, a lithium salt and an additive to obtain the electrolyte solution for the lithium-sulfur battery; the organic solvent is 1,1,2,2-tetrafluoroethyl 2,2,3,3-tetrafluoropropane ether and 1,3-dioxolane; the additive is a lithium-sulfur compound; the lithium-sulfur compound is Li₆S₂.

Preferably, the 1,1,2,2-tetrafluoroethyl 2,2,3,3-tetrafluoropropyl ether and the 1,3-dioxolane has a volume ratio of 1:(1-3).

Preferably, the mass ratio of the bis(hexafluoroethane) sulfonamide lithium salt and LiCF₃SO₃ is 1:(0.1-0.2).

Preferably, the lithium salt is bis(hexafluoroethane) sulfonamide lithium salt and LiCF₃SO₃; the bis(hexafluoroethane) sulfonamide lithium salt is prepared by the following method: Mixing benzyl bis (hexafluoro-ethyl) sulfonamide, a solvent and sulfuric acid, refluxing a resulting mixture, then adding Li₂O after cooling, continuing refluxing, filtering to obtain a filter residue, washing and drying the filter residue to obtain the bis(hexafluoroethane) sulfonamide lithium salt.

More preferably, the solvent is at least one of methanol, ethanol and acetone.

More preferably, the refluxing is carried out at a temperature of 80° C-100° C. for 6-12 hours.

More preferably, the cooling is performed to reach a temperature of 70° C-80° C., the continuing refluxing is carried out at a temperature of 70° C-80° C. for 12-18 hours.

More preferably, the washing is carried out with a solvent of at least one of methanol, ethanol and acetone.

More preferably, the drying is carried out at a temperature of 40-50° C.

Preferably, the LiCF₃SO₃ is prepared by the following method: mixing Li₂O, CF₃H and sulfuric acid, refluxing, and filtering to obtain a residue, washing and drying the residue to obtain the LiCF₃SO₃.

More preferably, the refluxing is performed at a temperature of 85° C-95° C. for 8-15 hours.

More preferably, the washing is carried out with a solvent of at least one of methanol, ethanol, and acetone.

Preferably, the Li₆S₂ is prepared by the following method: mixing Li₂O and sulfuric acid to perform a reaction, concentrating a resulting product, followed by washing and drying to obtain a solid, introducing a reducing gas and calcinating the solid to obtain the Li₆S₂.

More preferably, the calcinating is carried out at a temperature of 350° C-450° C. for 3-5 hours.

More preferably, the molar ratio of the Li₂O to the sulfuric acid is 1:(1-1.5).

More preferably, the concentration of the sulfuric acid is 0.1 to 0.3 mol/L.

More preferably, the reducing gas is CO.

Preferably, the Li₂O is prepared by the following methods: 1) dismantling a waste lithium battery, soaking and filtering to obtain a filtrate, distilling the filtrate to obtain an organic fraction A and an aqueous phase distillate; 2) adding a liquid alkali to the aqueous phase distillate, performing extraction and back-extraction to obtain an aqueous solution, introducing CO₂ gas to the aqueous solution to perform a reaction, filtering to obtain a product residue, washing, drying, and calcinating the product residue to obtain Li₂O.

Further preferably, in step 1), the soaking is carried out for 1-3 hours.

Further preferably, in step 1), the distilling is carried out under a pressure of 0.01-0.1 bar, and at a temperature of 50° C-70° C.

Further preferably, in step 1), the organic fraction A is vacuum distilled under a pressure of 0.01-0.1 bar and at a temperature of 55° C-65° C. to obtain an organic fraction B and an organic distillate. Wherein the organic distillate is treated as an organic waste liquid; the organic fraction B is recycled as a solvent A. The organic fraction A in step 1) is a mixture of a solvent and the electrolyte solvent component of the lithium-sulfur battery, the aqueous distillate is a wet salt of LiPF₆; the organic distillate is the electrolyte solvent component of the lithium-sulfur battery.

Further preferably, in step 2), the volume ratio of the aqueous distillate to the liquid alkali is 1:(1˜3). A Li-containing material is dissolved with the alkali to form a LiOH solution for extraction operation.

Further preferably, in step 2), the liquid alkali is one of NaOH or KOH.

Further preferably, in step 2), the extraction is carried out with an extractant of P204; the back-extraction is carried out with 0.1-0.3 mol/L sulfuric acid solution.

Further preferably, in step 2), the back-extraction is carried out with 0.1-0.3 mol/L sulfuric acid solution.

Further preferably, in step 2), the calcinating is carried out at a temperature of 90° C.-110° C. for 2-4 hours.

The present invention also provides a lithium-sulfur battery, comprising the electrolyte solution for a lithium-sulfur battery.

Advantages of the present invention:
1. The present invention first recovers a electrolyte solution from a lithium-sulfur battery, and then extracts the Li element in the electrolyte solution which is recycled to prepare a electrolyte solution for a lithium-sulfur battery; in addition, the organic components in the electrolyte solution of the waste lithium battery can be collected and subjected to a centralized treatment, which reduces leakage pollution.
2. The present invention uses a mixture of bis(hexafluoroethane) sulfonamide lithium salt and LiCF₃SO₃ as an electrolyte to improve the ion migration performance of the electrolyte solution of a lithium-sulfur battery.
3. The present invention adopts a mixture of 1,1,2,2-tetrafluoroethyl-2,2,3,3-tetrafluoropropyl ether and 1,3-dioxolane as an organic solvent of the electrolyte solution of the lithium-sulfur battery, which can weaken a shuttle behavior of poly-sulfur compounds in the battery.
4. In the present invention, Li₆S₂ is used as an additive, which can reduce dissolution of a positive electrode active material through buffering effect, and alleviate the “shuttle phenomenon”.

### BRIEF DESCRIPTION OF DRAWINGS

The above and/or additional aspects and advantages of the present invention will become obvious and easy to understand from the description of the embodiments in conjunction with the following drawings, in which:

The only FIGURE is a comparison diagram between the cycle performance of Example 2 of the present invention and the Comparative Example.

### DETAILED DESCRIPTION OF ILLUSTRATED EXAMPLES

In order to make technical solutions of the invention more clearly understood by those skilled in the art, the following examples are listed for explanation. It should be pointed out that the following examples are not intended to limit the protection scope claimed by the invention.

### Example 1

The method for preparing an electrolyte solution for a lithium-sulfur battery of this embodiment comprising the following specific steps:
(1) Disassembling a waste lithium-sulfur battery, and soaking it in methanol for 1 hour, filtering and removing an insoluble waste residue to obtain a filtrate; vacuum distilling the filtrate under a pressure of 0.01 bar and a temperature of 50° C. to obtain an organic fraction A (organic fraction A is vacuum distilled under a pressure of 0.01 bar and at a temperature of 55° C. to obtain an organic fraction B and an organic distillate, wherein the organic distillate is treated as an organic waste liquid, and the organic fraction B is methanol which is recycled) and an aqueous phase distillate;
(2) Adding 1 mol/L KOH solution to the aqueous phase distillate in a volume ratio of 1:1, then adding the extractant P204 in a volume ratio of 1:1 to perform extraction, and then adding 0.1 mol/L sulfuric acid solution in a volume ratio of 1:1 to perform back-extraction, separating an aqueous phase solution containing Li₂SO₄, and introducing CO₂ gas to the solution until a precipitation is complete, filtering to obtain a Li₂CO₃ residue, and washing the residue 3 times with methanol, and then drying at 50° C. followed by calcinating in air for 2 hours to obtain a Li₂O powder;
(3) Adding benzyl bis(hexafluoro-ethyl) sulfonamide, methanol, and concentrated sulfuric acid into a reflux apparatus according to a solid-liquid ratio of 1:3:0.6, refluxing at 80° C. for 6 hours, then adjusting the reflux system to a temperature of 70° C. Adding the Li₂O powder and benzyl bis(hexafluoro-ethyl) sulfonamide to the reflux apparatus in a molar ratio of 1:0.6, continuing refluxing at 70° C. for 12 hours, filtering to obtain a filter residue, washing it with methanol 3 times, and drying at 40° C. to obtain a bis(hexafluoroethane) sulfonamide lithium salt;
(4) Mixing the Li₂O powder, CF₃H and a concentrated sulfuric acid at a solid-to-liquid ratio of 1:4:0.3 in a reflux apparatus and refluxing at 85° C. for 8 hours, filtering to obtain a filter residue, washing the residue 3 times with methanol, and drying at 40° C. to obtain a LiCF₃SO₃ powder;
(5) Mixing the Li₂O powder with 0.1 mol/L sulfuric acid at a molar ratio of 1:1 to perform a reaction, concentrating a resulting product to obtain a solid by crystallization, washing the solid with methanol 3 times, and drying to obtain a solid powder. Placing the solid powder in a tube furnace, introducing CO gas and calcinating at 350° C. for 3 hours to obtain a Li₆S₂ powder;
(6) Mixing 1,1,2,2-tetrafluoroethyl-2,2,3,3-tetrafluoropropyl ether and 1,3-dioxolane in a volume ratio of 1:1 as an organic solvent, mixing the bis(hexafluoroethane) sulfonamide lithium salt and the LiCF₃SO₃ powder in a mass ratio of 1:0.1 as an electrolyte, and the Li6S2 powder as an additive, preparing an electrolyte solution for a lithium sulfur battery with the organic solvent, the electrolyte and the additive in a mass-to-volume ratio of 50:30:20.

### Example 2

The method for preparing an electrolyte solution for a lithium-sulfur battery of this embodiment comprising the following specific steps:
(1) Disassembling a waste lithium-sulfur battery, and soaking it in ethanol for 2 hours, filtering and removing an insoluble waste residue to obtain a filtrate; vacuum distilling the filtrate under a pressure of 0.05 bar and a temperature of 60° C. to obtain an organic fraction A (organic fraction A is vacuum distilled under a pressure of 0.05 bar and at a temperature of 60° C. to obtain an organic fraction B and an organic distillate, wherein the organic distillate is treated as an organic waste liquid, and the organic fraction B is ethanol which is recycled) and an aqueous phase distillate;
(2) Adding 1.5 mol/L KOH solution to the aqueous phase distillate in a volume ratio of 1:2, then adding an extractant P204 in a volume ratio of 1:2 to perform an extraction, and then adding 0.1 mol/L sulfuric acid solution in a volume ratio of 1:1.5 to perform a back-extraction, separating an aqueous phase solution containing Li₂SO₄, and introducing CO₂ gas to the solution until a precipitation is complete, filtering to obtain a Li₂CO₃ residue, and washing the residue 3 times with ethanol, and then drying at 55° C. followed by calcinating in air for 3 hours to obtain a Li₂O powder;
(3) Adding benzyl bis(hexafluoro-ethyl) sulfonamide, ethanol, and concentrated sulfuric acid into a reflux apparatus according to a solid-liquid ratio of 1:7:0.7, refluxing at 90° C. for 9 hours, then adjusting the reflux system to a temperature of 75° C. Adding the Li₂O powder and benzyl bis(hexafluoro-ethyl) sulfonamide to the reflux apparatus in a molar ratio of 1:0.8, continuing refluxing at 75° C. for 15 hours, filtering to obtain a filter residue, washing it with ethanol 3 times, and drying at 40° C. to obtain a bis(hexafluoroethane) sulfonamide lithium salt;
(4) Mixing the Li₂O powder, CF₃H and a concentrated sulfuric acid at a solid-to-liquid ratio of 1:8:0.4 in a reflux apparatus and refluxing at 90° C. for 12 hours, filtering to obtain a filter residue, washing the residue 3 times with ethanol, and drying at 40° C. to obtain a LiCF₃SO₃ powder;
(5) Mixing the Li₂O powder with 0.2 mol/L sulfuric acid at a molar ratio of 1:1.2 to perform a reaction, concentrating a resulting product to obtain a solid by crystallization, washing the solid with ethanol 3 times, and drying to obtain a solid powder. Placing the solid powder in a tube furnace, introducing CO gas and calcinating at 400° C. for 4 hours to obtain a Li₆S₂ powder;
(6) Mixing 1,1,2,2-tetrafluoroethyl 2,2,3,3-tetrafluoropropyl ether and 1,3-dioxolane in a volume ratio of 1:2 as an organic solvent, mixing the bis(hexafluoroethane) sulfonamide lithium salt and the LiCF₃SO₃ powder in a mass ratio of 1:0.15 as an electrolyte, and the Li₆S₂ powder as an additive, preparing an electrolyte solution for a lithium sulfur battery with the organic solvent, the electrolyte and the additive in a mass-to-volume ratio of 55:35:10.

### Example 3

The method for preparing an electrolyte solution for a lithium-sulfur battery of this embodiment comprising the following specific steps:
(1) Disassembling a waste lithium-sulfur battery, and soaking it in acetone for 3 hours, filtering and removing an insoluble waste residue to obtain a filtrate; vacuum distilling the filtrate under a pressure of 0.1 bar and a temperature of 70° C. to obtain an organic fraction A (organic fraction A is vacuum distilled under a pressure of 0.1 bar and at a temperature of 65° C. to obtain an organic fraction B and an organic distillate, wherein the organic distillate is treated as an organic waste liquid, and the organic fraction B is ethanol which is recycled) and an aqueous phase distillate;
(2) Adding 2 mol/L KOH solution to the aqueous phase distillate in a volume ratio of 1:3, then adding an extractant P204 in a volume ratio of 1:3 to perform extraction, and then adding 0.3 mol/L sulfuric acid solution in a volume ratio of 1:2 to perform back-extraction, separating an aqueous phase solution containing Li₂SO₄, and introducing CO₂ gas to the solution until a precipitation is complete, filtering to obtain a Li₂CO₃ residue, and washing the residue 3 times with ethanol, and then drying at 60° C. followed by calcinating in air for 4 hours to obtain a Li₂O powder;
(3) Adding benzyl bis(hexafluoro-ethyl) sulfonamide, acetone, and concentrated sulfuric acid into a reflux apparatus according to a solid-liquid ratio of 1:10:0.9, refluxing at 100° C. for 12 hours, then adjusting the reflux system to a temperature of 80° C. Adding the Li₂O powder and benzyl bis(hexafluoro-ethyl) sulfonamide to the reflux apparatus in a molar ratio of 1:1, continuing refluxing at 80° C. for 18 hours, filtering to obtain a filter residue, washing it with acetone 3 times, and drying at 40° C. to obtain a bis(hexafluoroethane) sulfonamide lithium salt;
(4) Mixing the Li₂O powder, CF₃H and a concentrated sulfuric acid at a solid-to-liquid ratio of 1:8:0.5 in a reflux apparatus and refluxing at 95° C. for 15 hours, filtering to obtain a filter residue, washing the residue 3 times with acetone, and drying at 40° C. to obtain a LiCF₃SO₃ powder;
(5) Mixing the Li₂O powder with 0.3 mol/L sulfuric acid at a molar ratio of 1:1.5 to perform a reaction, concentrating a resulting product to obtain a solid by crystallization, washing the solid with ethanol 3 times, and drying to obtain a solid powder. Placing the solid powder in a tube furnace, introducing CO gas and calcinating at 450° C. for 5 hours to obtain a Li₆S₂ powder;
(6) Mixing 1,1,2,2-tetrafluoroethyl 2,2,3,3-tetrafluoropropyl ether and 1,3-dioxolane in a volume ratio of 1:3 as an organic solvent, mixing the bis(hexafluoroethane) sulfonamide lithium salt and the LiCF₃SO₃ powder in a mass ratio of 1:0.2 as an electrolyte, and the Li6S2 powder as an additive, preparing an electrolyte solution for a lithium sulfur battery with the organic solvent, the electrolyte and the additive in a mass-to-volume ratio of 55:35:10.

### Comparative Example

A method for preparing an electrolyte solution for a lithium-sulfur battery comprising the following steps:

An electrolyte solution for a lithium-sulfur battery comprises of a linear ether solvent, a cyclic ether solvent, a conductive lithium salt and a metal phthalocyanine compound. Mixing the linear ether solvent and cyclic ether solvent to prepare a mixed solvent, adding the conductive lithium salt to the mixed solvent to obtain an electrolyte solution for a basic lithium sulfur battery, and then adding the metal phthalocyanine compound to the electrolyte solution for a basic lithium-sulfur battery to obtain the electrolyte solution for a lithium-sulfur battery.

### Performance Testing

The electrolyte solution for the lithium-sulfur batteries prepared in the foregoing Examples 1-3 and Comparative Example were tested for viscosity, dielectric constant, electrical conductivity, chroma, density, moisture, free acid, sulfate and other physical properties. The results are shown in Table 1. It can be seen from Table 1 that the viscosity, dielectric constant, electrical conductivity and other related indexes affecting electrochemical performance of the electrolyte solution of Comparative Example are all lower than those of Examples 1, 2 and 3, while other indexes are not as good as those of Examples 1, 2, and 3. Among the examples, Example 2 indicates best relevant performance indexes.

TABLE 1
Basic physical properties of the electrolyte
solution for the lithium sulfur battery

| | Example | Example | Example | Comparative |
|---|---|---|---|---|
| Item | 1 | 2 | 3 | Example |
| Viscosity | 2.9 | 2.3 | 2.6 | 3.1 |
| mPa · s | | | | |
| Dielectric | 37.78 | 46.68 | 37.26 | 24.46 |
| constant | | | | |
| F/m | | | | |
| Conductivity | 2.57 | 2.79 | 2.61 | 1.28 |
| mS/cm | | | | |
| Color | 22.3 | 11.2 | 29.5 | 42.9 |
| hazen | | | | |
| Density | 0.87 | 0.87 | 0.86 | 1.2 |
| g/cm³ | | | | |
| Moisture | 0.0010 | 0.0010 | 0.0011 | 0.0020 |
| content | | | | |
| w/% | | | | |
| Free acid | 0.0042 | 0.0039 | 0.0043 | 0.0050 |
| w/% | | | | |
| Sulfate | 0.0008 | 0.0007 | 0.0008 | 0.0010 |
| w/% | | | | |

The electrolyte solution for lithium-sulfur batteries prepared in the above-mentioned Examples 1-3 and Comparative Example were assembled into lithium-sulfur batteries with sulfur element as a positive electrode of the battery and a lithium metal as a negative electrode. The first discharge test was performed at a rate of 1C, the results of which are shown in the Table 2 and Table 3. According to Table 2, at a rate of 1C, the first discharge specific capacity of the lithium-sulfur battery using the electrolyte solution prepared in Examples 1-3 of the present invention is higher than that of the Comparative Example, and the first discharge specific capacity of Example 2 is 1662.3 mAh/g, while the first discharge specific capacity of the Comparative Example was only 1043.1 mAh/g. According to Table 3, the cycle life of the lithium-sulfur battery using the electrolyte solution of the lithium-sulfur battery prepared in Examples 1-3 of the present invention is higher than that of the Comparative Example at a 1C rate. After 1000 cycles, the capacity retention rate of Example 2 is 92.3%, while the capacity retention rate of the Comparative Example is only 80.8%.

TABLE 2
Performance of a button cell

| | Example | Example | Example | Comparative |
|---|---|---|---|---|
| Item | 1 | 2 | 3 | Example |
| First discharge | 1511.9 | 1662.3 | 1492.1 | 1043.1 |
| capacity mAh/g | | | | |
| First charge- | 91.1 | 95.9 | 92.9 | 89.2 |
| discharge | | | | |
| rate % | | | | |

TABLE 3
Cycle performance of a full battery

| | Example | Example | Example | Comparative |
|---|---|---|---|---|
| Item | 1 | 2 | 3 | Example |
| Discharge capacity | 84.2 | 92.3 | 86.3 | 80.8 |
| retention rate after | | | | |
| 1000cycles at 1 C % | | | | |

The only FIGURE is a comparison diagram of the cycle performance between Example 2 of the present invention and the Comparative Example. As can be obtained from the only FIGURE, the capacity of Example 2 is much higher than that of the Comparative Example

The electrolyte solution for a lithium sulfur battery, the preparation method and application thereof provided by the invention have been described in detail above. Specific examples are used herein to illustrate the principles and implementation of the invention. The above description of examples is only for the purpose of helping understand methods and core concepts of the invention, including best modes, and also enables any person skilled in the art to practice the invention, including manufacture and use of any device or system, and implementation of any combined methods. It should be noted that several improvements and modifications can be made by those skilled in the art to the invention without departing from the principles of the invention, which improvements and modifications also fall within the protection scope claimed by the claims. The protection scope of the invention is defined by the claims and may include other embodiments that can be thought of by those skilled in the art. If these other embodiments have structural elements that are not different from the literal expression of the claims, or if they include equivalent structural elements that are not substantially different from the literal expression of the claims, these other embodiments should also be included within the scope of the claims.

1. An electrolyte solution for a lithium-sulfur battery, comprising an organic solvent, an electrolyte and an additive; wherein the organic solvent is 1,1,2,2-tetrafluoroethyl 2,2,3,3-tetrafluoropropane ether and 1,3-dioxolane; the electrolyte is a lithium salt; the additive is a lithium-sulfur compound; the lithium-sulfur compound is Li₆S₂.

2. The electrolyte solution according to claim 1, wherein the lithium salt is bis(hexafluoroethane) sulfonamide lithium salt and LiCF₃SO₃.

3. The electrolyte solution according to claim 1, wherein the electrolyte solution for the lithium-sulfur battery has a dielectric constant of 37.26-46.68 F/m and a conductivity of 2.57-2.79 mS/cm.

4. A preparation method for the electrolyte solution of claim 1, comprising the following steps:
(1) Mixing an organic solvent, a lithium salt and an additive to obtain the electrolyte solution; the organic solvent is 1,1,2,2-tetrafluoroethyl 2,2,3,3-tetrafluoropropane ether and 1,3-dioxolane; the additive is a lithium-sulfur compound; the lithium-sulfur compound is Li₆S₂.

5. The preparation method according to claim 4, wherein the lithium salt is bis(hexafluoroethane) sulfonamide lithium salt and LiCF₃SO₃; wherein the bis(hexafluoroethane) sulfonamide lithium salt is prepared by the following method: mixing benzyl bis (hexafluoro-ethyl) sulfonamide, a solvent and sulfuric acid, refluxing a resulting mixture, then adding Li₂O after cooling, continuing refluxing, filtering to obtain a filter residue, washing and drying the filter residue to obtain the bis(hexafluoroethane) sulfonamide lithium salt; wherein the LiCF₃SO₃ is prepared by the following method: mixing Li₂O, CF₃H and sulfuric acid to obtain a mixture, refluxing the mixture, filtering to obtain a residue, washing and drying the residue to obtain the LiCF₃SO₃.

6. The preparation method according to claim 5, wherein the solvent is at least one selected from the group consisting of methanol, ethanol and acetone.

7. The preparation method according to claim 4, wherein the Li₆S₂ is prepared by the following method: mixing Li₂O and sulfuric acid to perform a reaction, concentrating a resulting product, followed by washing and drying to obtain a solid, introducing a reducing gas and calcinating the solid to obtain the Li₆S₂.

8. The preparation method according to claim 7, wherein the calcinating is carried out at a temperature of 350° C-450° C. for 3-5 hours; wherein the reducing gas is CO.

9. The preparation method according to claim 5, wherein the Li₂O is prepared by the following method:
1) dismantling a waste lithium battery, soaking and filtering to obtain a filtrate, distilling the filtrate to obtain an organic fraction A and an aqueous phase distillate;
2) adding an alkali liquid to the aqueous phase distillate, performing extraction and then back-extraction to obtain an aqueous phase solution, introducing CO₂ gas to the aqueous phase solution to perform a reaction, filtering to obtain a product residue, washing, drying, and calcinating the product residue to obtain Li₂O;
in step 2), an extractant for the extraction is P204; a 0.1-0.3 mol/L sulfuric acid solution is used for the back extraction; the alkali liquid is one of NaOH or KOH.

10. The preparation method according to claim 7, wherein the Li₂O is prepared by the following method:
1) dismantling a waste lithium battery, soaking and filtering to obtain a filtrate, distilling the filtrate to obtain an organic fraction A and an aqueous phase distillate;
2) adding an alkali liquid to the aqueous phase distillate, performing extraction and then back-extraction to obtain an aqueous phase solution, introducing CO₂ gas to the aqueous phase solution to perform a reaction, filtering to obtain a product residue, washing, drying, and calcinating the product residue to obtain Li₂O;
in step 2), an extractant for the extraction is P204; a 0.1-0.3 mol/L sulfuric acid solution is used for the back extraction; the alkali liquid is one of NaOH or KOH.

11. A lithium-sulfur battery comprising the electrolyte solution for the lithium-sulfur battery of claim 1.

12. A lithium-sulfur battery comprising the electrolyte solution for the lithium-sulfur battery of claim 2.

13. A lithium-sulfur battery comprising the electrolyte solution for the lithium-sulfur battery of claim 3.
